(19) United States
(12) Patent Application Publication
(10) Pub. No.: US 2017/0253981 A1
(43) Pub. Date: Sep. 7, 2017

(54) PHOTOELECTRODE, METHOD FOR MANUFACTURING SAME, AND PHOTOELECTROCHEMICAL CELL

(71) Applicant: Panasonic Intellectual Property Management Co., Ltd., Osaka (JP)

(72) Inventors: SATORU TAMURA, Osaka (JP); TAKAHIRO KURABUCHI, Osaka (JP); RYOSUKE KIKUCHI, Osaka (JP); TAKAIKI NOMURA, Osaka (JP); KAZUHITO HATO, Osaka (JP)

(21) Appl. No.: 15/416,011

(22) Filed: Jan. 26, 2017

(30) Foreign Application Priority Data
Mar. 1, 2016 (JP) 2016-039090

(51) Int. Cl. C25B 11/04; H01G 9/20; C25B 1/04; C25B 1/00

(52) U.S. Cl. CPC C25B 11/0405; C25B 1/003; H01G 9/2027; C25B 11/0478; C25B 1/04

(57) ABSTRACT

The present invention provides a photoelectrode capable of effectively utilizing energy of light for an intended reaction such as a water decomposition reaction. The present invention provides a photoelectrode 100 includes a first conductor 101 as a substrate; a second conductor 102 which is disposed on first conductor 101, has a porous structure including a three-dimensionally continuous skeleton 102a and pores 102b formed by the skeleton 102a, and is transparent; and a visible-light photocatalyst 103 disposed in the pores of the second conductor 102.

### BACKGROUND

1. Technical Field

The present disclosure relates to a photoelectrode, a method for manufacturing the photoelectrode, and a photoelectrochemical cell.

2. Description of the Related Art

Real practical use of renewable energy is required for realizing a sustainable society by solving a growing environmental and energy problems. Currently, systems in which electric power generated by a solar cell is stored in a storage battery are being widely spread. However, the storage battery is heavy, and thus is not easy to move. Thus, in the future, utilization of hydrogen as an energy medium is expected.

Natures of hydrogen are as follows.

Hydrogen is easily stored and moved.

When hydrogen is burned, a resultant final product is harmless and safe water, and hence clean.

Hydrogen can be converted into electricity and heat by utilizing a fuel cell.

Hydrogen is inexhaustibly obtained by decomposition of water.

A semiconductor photoelectrode that decomposes water by sunlight to produce hydrogen is attracting attention as a technique capable of converting solar energy into hydrogen as an easily utilizable energy medium, and is being researched and developed for improving efficiency of a reaction.

For example, Patent Literature 1 discloses a semiconductor photoelectrode which includes a metal substrate having irregularities on a surface; and a semiconductor layer formed on a surface of the metal substrate and made of a material having a photocatalytic action. In this structure, light absorption efficiency is improved by light scattering from the irregular structure on the surface, and a thickness of the semiconductor layer is set to 1 μm or less to reduce recombination of charges, so that a semiconductor photoelectrode having improved energy conversion efficiency can be produced.

### CITATION LIST

### Patent Literature

Patent Literature 1: Unexamined Japanese Patent Publication No. 2006-297300

### SUMMARY

An object of the present disclosure is to provide a photoelectrode capable of effectively utilizing energy of light for an intended reaction such as a water decomposition reaction.

The present disclosure provides a photoelectrode including:

a first conductor as a substrate;

a second conductor which is disposed on the first conductor, has a porous structure including a three-dimensionally continuous skeleton and pores formed by the skeleton, and is transparent; and

a visible-light photocatalyst disposed in the pores of the second conductor.

According to the present disclosure, there can be provided a photoelectrode capable of effectively utilizing energy of light for an intended reaction such as a water decomposition reaction.

### BRIEF DESCRIPTION OF THE DRAWINGS

FIG. 1 is a schematic view showing one example of a photoelectrode according to one exemplary embodiment of the present disclosure.

FIG. 2 is a schematic view showing a reference plane, a thickness determination plane and a central plane taking as an example the photoelectrode shown in FIG. 1.

FIG. 3 is a schematic view showing one example of a photoelectrochemical cell according to one exemplary embodiment of the present disclosure.

FIG. 4 is a schematic view showing another example of a photoelectrochemical cell according to one exemplary embodiment of the present disclosure.

### DETAILED DESCRIPTION OF THE EMBODIMENTS

The semiconductor photoelectrode in Patent Literature 1 has such a problem that light incident on an electrode cannot be effectively utilized for an intended reaction such as a water decomposition reaction. This is because a part of light incident on the electrode arrives at the metal substrate after entering the semiconductor layer, and is absorbed by the metal substrate. When the semiconductor layer is thickened for increasing a light absorption amount in the semiconductor layer, a distance over which photo-excited carriers (electrons and holes) move through the semiconductor layer increases, and therefore recombination of carriers occurs, so that the carriers can no longer contribute to a reaction such as a water decomposition reaction.

A photoelectrode according to a first aspect of the present disclosure includes a first conductor as a substrate; a second conductor which is disposed on the first conductor, has a porous structure including a three-dimensionally continuous skeleton and pores formed by the skeleton, and is transparent; and a visible-light photocatalyst disposed in the pores of the second conductor. A photoelectrode according to the first aspect can be considered as a photoelectrode including the first conductor; and a composite which is disposed on the first conductor and composed of the second conductor and the visible-light photocatalyst. Hereinafter, the composite composed of the second conductor and the visible-light photocatalyst may be referred to simply as a “composite”.

In the photoelectrode according to the first aspect, most of light, which is incident on the photoelectrode, and enters the second conductor without being absorbed into the visible-light photocatalyst, passes through the second conductor without being absorbed into the second conductor, then enters the visible-light photocatalyst again, and is absorbed by the visible-light photocatalyst. Thus, in the photoelectrode according to the first aspect, a thickness as the composite is increased to increase an optical path length over which light passes through the visible-light photocatalyst, so that a light absorption rate can be improved even when a thickness of the visible-light photocatalyst itself is decreased. In other words, in the photoelectrode according to the first aspect, the thickness of the visible-light photocatalyst can be sufficiently decreased to suppress recombination of photo-excited carriers. Thus, in the photoelectrode according to the first aspect, most of light incident on the photoelectrode can be absorbed into the photocatalyst, and the thickness of the photocatalyst can be decreased to suppress recombination of photo-excited carriers, so that energy of light incident on the photoelectrode can be effectively utilized for an intended reaction such as a water decomposition reaction.

A photoelectrode according to a second aspect may be, for example, the photoelectrode according to the first aspect, wherein the visible-light photocatalyst contains at least one of a niobium nitride and a niobium oxynitride.

In the photoelectrode according to the second aspect, the visible-light photocatalyst can utilize light having a wavelength up to that in a visible light region, and a band structure of the visible-light photocatalyst is suitable for water decomposition. Thus, in the photoelectrode according to the second aspect, energy of light incident on the photoelectrode can be more effectively utilized for an intended reaction such as a water decomposition reaction when, for example, sunlight is used as a light source.

A photoelectrode according to a third aspect may be, for example, the photoelectrode according to the first or second aspect, wherein a resistivity of the first conductor is lower than a resistivity of the second conductor.

A distance over which electrons move is usually larger in the first conductor than in the second conductor. In the photoelectrode according to the third aspect, a movement loss of electrons can be suppressed because the resistivity of the first conductor may be lower than the resistivity of the second conductor.

A photoelectrode according to a fourth aspect may be, for example, the photoelectrode according to the third aspect, wherein the first conductor is formed of a metal, and the second conductor is formed of a transparent conductive oxide.

In the photoelectrode according to the fourth aspect, there is a wide range of selection of a material of the first conductor, and high conductivity of the first conductor can be achieved because the first conductor is formed of a metal. Generally, a metal has a resistivity lower than that of a transparent conductive oxide, and therefore by using a metal for formation of the first conductor, a range of selection of the trans parent conductive oxide to be used for formation of the second conductor can also be widened.

A photoelectrode according to a fifth aspect may be, for example, the photoelectrode according to the third aspect, wherein the first conductor is formed of a first transparent conductive oxide, the second conductor is formed of a second transparent conductive oxide, and a resistivity of the first transparent conductive oxide is lower than a resistivity of the second transparent conductive oxide.

In the photoelectrode according to the fifth aspect, a degree of freedom of a light-incident surface in the photoelectrode is high because the first conductor is transparent. In the photoelectrode according to the fifth aspect, a surface on the first conductor side, a surface on a side opposite to the foregoing surface, or each of both the surfaces may be the light-incident surface.

A photoelectrode according to a sixth aspect may be, for example, the photoelectrode according to any one of the first to fifth aspects, wherein the second conductor is formed of at least one selected from the group consisting of antimony-doped tin oxide, fluorine-doped tin oxide and gallium-doped zinc oxide.

In the photoelectrode according to the sixth aspect, the second conductor is formed of at least one selected from the group consisting of antimony-doped tin oxide, fluorine-doped tin oxide and gallium-doped zinc oxide. Thus, the photoelectrode according to the sixth aspect is industrially easily and conveniently manufactured. Antimony-doped tin oxide and fluorine-doped tin oxide have high-temperature resistance, and therefore can be used without problems even when a step of forming a visible-light photocatalyst includes a firing process. Gallium-doped zinc oxide has high resistance in a reducing atmosphere, and therefore can be used without problems even when, for example, the visible-light photocatalyst is a nitride and/or an oxynitride, and a firing step is carried out under an ammonia gas atmosphere in synthesis of the visible-light photocatalyst.

A photoelectrode according to a seventh aspect may be, for example, the photoelectrode according to any one of the first to sixth aspects, wherein the porous structure is a co-continuous structure, or a particulate porous structure in which the skeleton is formed by aggregation of fine particles.

In the photoelectrode according to the seventh aspect, a second conductor having pores for disposing a visible-light photocatalyst that is sufficient to achieve a high light absorption rate can be easily provided.

A photoelectrode according to an eighth aspect may be, for example, the photoelectrode according to any one of the first to seventh aspects, wherein in the second conductor, a porosity of a region on a first conductor side with respect to a central plane of the second conductor is lower than a porosity of a region on a side opposite to the first conductor with respect to the central plane. Here, the central plane is a central plane in a thickness of the second conductor, the thickness of the second conductor is determined by a distance between a reference plane and a thickness determination plane where the reference plane is a surface of the first conductor on which the second conductor is disposed, and the thickness determination plane is a plane which extends through a position farthest from the reference plane in the skeleton of the second conductor, and is parallel to the reference plane, and the central plane in the thickness of the second conductor is a central plane between the reference plane and the thickness determination plane.

In the photoelectrode according to the eighth aspect, a probability that scattering of light incident on the composite is directed to the first conductor side increases, and therefore the light easily arrives at an inside of the composite, so that a light absorption amount of the visible-light photocatalyst positioned in the pores of the second conductor increases, leading to improvement of light utilization efficiency. Further, when the photoelectrode according to the eighth aspect is utilized as an electrode for water decomposition, bubbles (of hydrogen or oxygen) produced through a water decomposition reaction in the pores of the second conductor are easily released outside the photoelectrode.

A method for manufacturing a photoelectrode according to a ninth aspect of the present disclosure is a method for manufacturing the photoelectrode according to any one of the first to eighth aspects, the method including:

forming on a first conductor as a substrate a second conductor which has a porous structure including a three-dimensionally continuous skeleton and pores formed by the skeleton, and is transparent; and

forming a visible-light photocatalyst disposed in the pores of the second conductor.

In the manufacturing method according to the ninth aspect, a photoelectrode can be manufactured at a low cost without carrying out complicated steps.

A method according to a tenth aspect may be, for example, the method for manufacturing a photoelectrode according to the ninth aspect, wherein the visible-light photocatalyst is at least one selected from a nitride and an oxynitride, and an oxide or an organic compound as a precursor of the visible-light photocatalyst is subjected to a nitridization treatment with a nitrogen compound gas to form the visible-light photocatalyst.

In the manufacturing method according to the tenth aspect, a nitride and/or an oxynitride as the visible-light photocatalyst can be formed by an easy and convenient method in which an oxide or an organic compound as a precursor is subjected to a nitridization treatment.

A photoelectrochemical cell according to an eleventh aspect of the present disclosure includes: the photoelectrode according to any one of the first to eighth aspects; a counter electrode electrically connected to the photoelectrode; and a container that stores the photoelectrode and the counter electrode.

The photoelectrochemical cell according to the eleventh aspect includes the photoelectrode according to any one of the first to eighth aspects, so that energy of light incident on the photoelectrode can be effectively utilized for a water decomposition reaction.

A photoelectrochemical cell according to a twelfth aspect may be the photoelectrochemical cell according to the eleventh aspect, further including an electrolytic solution which contains water, which is stored in the container and which is in contact with surfaces of the photoelectrode and the counter electrode.

In the photoelectrochemical cell according to the twelfth aspect, energy of light incident on the photoelectrode can be effectively utilized for a water decomposition reaction.

A photoelectrochemical cell according to a thirteenth aspect may be the photoelectrochemical cell according to the eleventh or twelfth aspect, wherein the first conductor of the photoelectrode is formed of a metal, and the photoelectrode is disposed in such a direction that light is capable of being incident from a surface on a side opposite to the first conductor.

In the photoelectrochemical cell according to the thirteenth aspect, a part of light having passed through the composite is reflected on a surface of the first conductor, then enters the composite again, and is absorbed by the visible-light photocatalyst, and therefore light utilization efficiency can be further improved.

A photoelectrochemical cell according to a fourteenth aspect is the photoelectrochemical cell according to the eleventh or twelfth aspect, wherein the first conductor of the photoelectrode is formed of a transparent conductive material, and the photoelectrode is disposed in such a direction that light is capable of being incident from a surface on the first conductor side.

In the photoelectrochemical cell according to the fourteenth aspect, light is incident on the photoelectrode from the first conductor side, and therefore an amount of light absorbed by the visible-light photocatalyst disposed at a position close to the first conductor increases, so that an amount of photo-excited carriers produced at the position close to the first conductor increases. A distance over which the photo-excited carriers produced at a position close to the first conductor move to the first conductor is short, and therefore recombination of carriers is hard to occur. As a result, an amount of carriers capable of contributing to the water decomposition reaction increases, so that high utilization efficiency of energy of light can be achieved. In the photoelectrochemical cell according to the fourteenth aspect, each of both a surface on the first conductor side and a surface on a side opposite to the foregoing surface can be the light-incident surface in the photoelectrode.

Hereinafter, exemplary embodiments of the photoelectrode and the photoelectrochemical cell of the present disclosure will be described in detail. The following exemplary embodiments are illustrative, and the present disclosure is not limited to the following exemplary embodiments.

### First Exemplary Embodiment

A photoelectrode of a first exemplary embodiment includes a first conductor as a substrate, and a second conductor disposed on the first conductor. The second conductor has a porous structure including a three-dimensionally continuous skeleton and pores formed by the skeleton, and is transparent. The photoelectrode of this exemplary embodiment further includes a visible-light photocatalyst disposed in the pores of the second conductor. The visible-light photocatalyst should be disposed at least in the pores of the second conductor, and may be disposed further on a surface of the second conductor. The visible-light photocatalyst may be in the form of particles, or in the form of a film. It can be considered that a photocatalyst layer including a visible-light photocatalyst is disposed in the pores of the second conductor in the photoelectrode of this exemplary embodiment.

The phrase “the skeleton of the second conductor is three-dimensionally continuous” encompasses not only a case where the skeleton is a continuous body, but also a case where the skeleton is formed by aggregation of fine particles, and can be considered to be substantially continuous. Thus, the porous structure of the second conductor may be a structure in which the skeleton is a continuous body like a co-continuous structure, or may be a particulate porous structure in which the skeleton is formed by aggregation of fine particles.

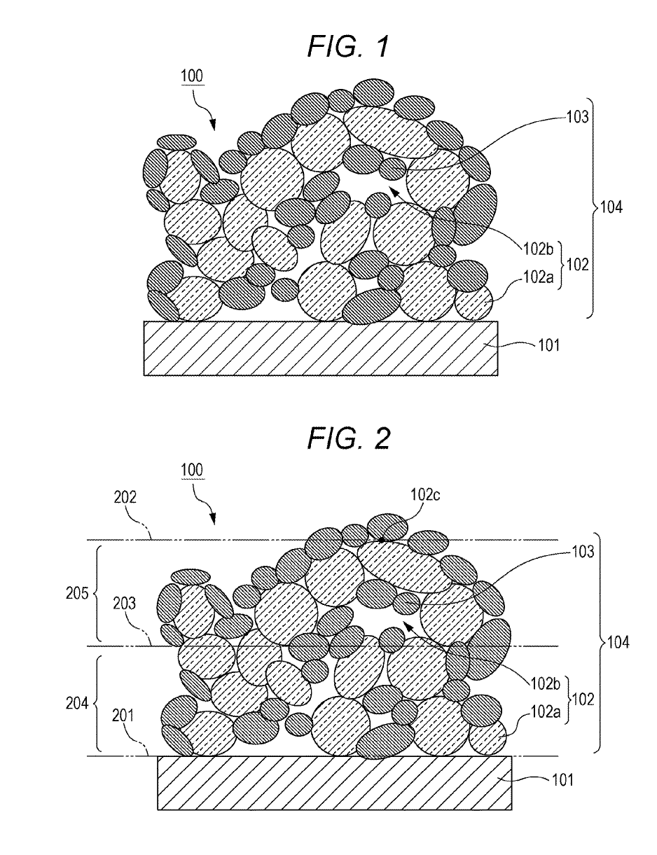

FIG. 1 is a schematic view showing one example of the photoelectrode of this exemplary embodiment, where the skeleton of the second conductor is formed by aggregation of fine particles. Photoelectrode 100 shown in FIG. 1 includes first conductor 101 as a substrate, and second conductor 102 and visible-light photocatalyst 103 disposed on first conductor 101. Second conductor 102 has a porous structure including three-dimensionally continuous skeleton 102a and pores 102b formed by skeleton 102a, and is transparent. Visible-light photocatalyst 103 is disposed in pores 102b of second conductor 102. Visible-light photocatalyst 103 may be disposed not only in pores 102b but also on a surface of second conductor 102.

The pores in the second conductor may be opened at a surface of the second conductor on a side opposite to the first conductor. In this structure, bubbles (of hydrogen or oxygen) produced through a water decomposition reaction in the pores can be easily released outside the electrode from insides of the pores through the opening when the photoelectrode of this exemplary embodiment is utilized as an electrode for water decomposition. The pores in the second conductor may include three-dimensionally continuous pores, or may include isolated pores that are not connected with other pores.

In the photoelectrode of this exemplary embodiment, most of light, which is incident on the photoelectrode, and enters the second conductor without being absorbed into the visible-light photocatalyst, passes through the second conductor without being absorbed into the second conductor, then enters the visible-light photocatalyst again, and is absorbed by the visible-light photocatalyst.

In the structure of the photoelectrode of this exemplary embodiment, the thickness of the visible-light photocatalyst can be sufficiently decreased to suppress recombination of photo-excited carriers. This is because when the thickness of the composite is increased, an optical path length over which light passes through the visible-light photocatalyst increases, so that a light absorption rate can be improved even when the thickness of the visible-light photocatalyst itself is small. Thus, in the photoelectrode of this exemplary embodiment, most of incident light can be absorbed into the photocatalyst, and a thickness of the photocatalyst can be decreased to suppress recombination of photo-excited carriers, so that energy of incident light can be effectively utilized for an intended reaction such as a water decomposition reaction.

A porosity in the second conductor may be uniform throughout the second conductor, or may be varied. For example, in the second conductor, a porosity of a region on a first conductor side with respect to a central plane of the second conductor is preferably lower than a porosity of a region on a side opposite to the first conductor with respect to the central plane. Here, the central plane of the second conductor is a central plane in a thickness of the second conductor. The thickness of the second conductor is determined by a distance between a reference plane and a thickness determination plane where the reference plane is a surface of the first conductor on which the second conductor is disposed, and the thickness determination plane is a plane which extends through a position farthest from the reference plane in the skeleton of the second conductor, and is parallel to the reference plane. The central plane in the thickness of the second conductor is a central plane between the reference plane and the thickness determination plane. The planes defined in this way will be described below taking photoelectrode 100 shown in FIG. 1 as an example. As shown in FIG. 2, reference plane 201 is a surface of first conductor 101 on which second conductor 102 (composite 104) is disposed. Thickness determination plane 202 is a plane which extends through position 102c farthest from reference plane 201 in skeleton 102a of second conductor 102, and is parallel to reference plane 201. Central plane 203 is a central plane between reference plane 201 and thickness determination plane 202. In FIG. 2, reference numeral 204 denotes a region on the first conductor side with respect to central plane 203, and reference numeral 205 denotes a region on a side opposite to the first conductor with respect to central plane 203.

In other words, the above-mentioned configuration is such that the skeleton of the second conductor is dense in the region on the first conductor side, and sparse in the region on a side opposite to the first conductor. In this configuration, a probability that scattering of light incident on the composite is directed to the first conductor side of the composite increases, and therefore the light easily arrives at an inside of the composite, so that a light absorption amount of the visible-light photocatalyst positioned in the pores of the second conductor increases, leading to improvement of light utilization efficiency. Further, when the photoelectrode of this exemplary embodiment is utilized as an electrode for water decomposition, bubbles (of hydrogen or oxygen) produced through a water decomposition reaction in the pores of the second conductor are easily released outside the photoelectrode. More preferably, the porosity of the second conductor increases from the first conductor side toward the side opposite to the first conductor, that is to say, a density of the skeleton of the second conductor decreases from the first conductor side toward the side opposite to the first conductor. In this configuration, utilization efficiency of the visible-light photocatalyst disposed in the pores of the second conductor can be further improved.

The porosity of the second conductor can be determined by image analysis of a cross section of the second conductor along a thickness direction of the first conductor. Specifically, the porosity can be determined in the following manner: the cross-sectional image of the second conductor is binarized, binarized image data in which, for example, a skeleton section is white and a void section is black, is provided, and a number of pixels in the black section, i.e. the void section is counted.

The second conductor is formed of a transparent conductive material such as a transparent conductive oxide. The transparent conductive material is a material which has a low absorption rate for light in a visible light region with a wavelength above 400 nm and which has conductivity. Here, the “low absorption rate for light in a visible light region with a wavelength above 400 nm” means that a light absorption coefficient for light in a visible light region with a wavelength of 500 nm is 1000 cm⁻¹ or less, preferably 500 cm⁻¹ or less. Since the second conductor has a porous structure, light incident on the second conductor may be reflected/scattered to appear white. However, since the transparent conductive material that forms the second conductor has a low light absorption coefficient in, for example, the above-mentioned range for light in a visible light region, light absorption hardly occurs in the second conductor, and most of incident light is absorbed by the visible-light photocatalyst at the time when the light passes through the visible-light photocatalyst. Conductivity required for the transparent conductive material to be used in the second conductor corresponds to a resistivity of 1×10⁻¹ Ω·cm or less, preferably a resistivity of 1×10⁻² Ω·cm or less.

Examples of the transparent conductive material to be used for formation of the second conductor in this exemplary embodiment include transparent conductive oxides such as antimony-doped tin oxide (ATO), niobium-doped tin oxide (NbTO), tantalum-doped tin oxide (TaTO), fluorine-doped tin oxide (FTO), tin-doped indium oxide (ITO), aluminum-doped zinc oxide (AZO), gallium-doped zinc oxide (GZO) and niobium-doped titanium dioxide. Preferably, the second conductor is formed of at least one selected from the group consisting of ATO, FTO and GZO in particular. By using ATO, FTO and GZO, the photoelectrode of this exemplary embodiment can be industrially easily and conveniently produced. More preferably, a material having durability to a step of forming the visible-light photocatalyst is selected as the transparent conductive material to be used in the second conductor. ATO and FTO have higher high-temperature resistance as compared to ITO, and therefore can be used without problems even when a step of forming a visible-light photocatalyst includes a firing process. GZO has high resistance in a reducing atmosphere, and therefore can be used without problems even when, for example, the visible-light photocatalyst is a nitride and/or an oxynitride, and a firing step is carried out under an ammonia gas atmosphere in synthesis of the visible-light photocatalyst.

The visible-light photocatalyst is a photocatalyst capable of absorbing light in a visible light region with a wavelength above 400 nm. The visible-light photocatalyst has a light absorption coefficient of 5000 cm⁻¹ or more, preferably 10000 cm⁻¹ or more for light in a visible light region with a wavelength of 500 nm. The visible-light photocatalyst in this exemplary embodiment can utilize visible light from sunlight as described above, and is therefore capable of increasing utilization efficiency of sunlight as compared to a photocatalyst that can absorb only ultraviolet rays, such as TiO₂. Typical examples of the photocatalyst capable of absorbing light in a visible light region include iron oxide (Fe₂O₃), tungsten oxide (WO₃), tantalum nitride (Ta₃N₅), tantalum oxynitride (TaON), niobium nitride (Nb₃N₅) and niobium oxynitride (NbON).

Particularly, when the visible-light photocatalyst is at least one of a niobium nitride and a niobium oxynitride such as niobium nitride (Nb₃N₅) and niobium oxynitride (NbON), the visible-light photocatalyst can utilize light having a wavelength up to that in a visible light region, and a band structure of the visible-light photocatalyst is suitable for water decomposition. Thus, when such a visible-light photocatalyst is used, it is possible to provide a photoelectrode capable of more effectively utilizing energy of light incident on the photoelectrode for an intended reaction such as a water decomposition reaction when, for example, sunlight is used as a light source. A niobium-based compound can be prepared at a lower cost as compared to a Ta-based compound, and is therefore suitable for industrial use.

Preferably, the thickness of the visible-light photocatalyst is, for example, 10 nm to 200 nm for sufficiently absorbing light and preventing recombination of photo-excited carriers as described above. In the photoelectrode of this exemplary embodiment, most of light, which once enters the visible-light photocatalyst, but passes through the visible-light photocatalyst and arrives at the second conductor without being absorbed into the visible-light photocatalyst, passes through the second conductor, arrives at the visible-light photocatalyst disposed in the pores of the second conductor, and is absorbed by the visible-light photocatalyst. Thus, the thickness of the visible-light photocatalyst can be reduced without decreasing the optical path length over which light incident on the photoelectrode passes through the visible-light photocatalyst.

Preferably, materials and Fermi levels of the visible-light photocatalyst and the second conductor are appropriately selected in such a manner that a contact between the visible-light photocatalyst and the second conductor is an ohmic contact. When the contact between the visible-light photocatalyst and the second conductor is an ohmic contact, a probability that electrons and holes produced in the visible-light photocatalyst by photo-excitation are charge-separated and recombined further decreases, and therefore utilization efficiency of light energy can be further improved.

The first conductor may be formed of a metal, or may be formed of a transparent conductive material. Conductivity required for the material to be used in the first conductor corresponds to a resistivity of 1×10⁻³ Ω·cm or less, preferably a resistivity of 1×10⁻⁴ Ω·cm or less. Here, the resistivity required for the material of the first conductor is lower than the resistivity required for the material of the second conductor (1×10⁻¹ Ω·cm or less, preferably 1×10⁻² Ω·cm or less) because a distance over which photo-excited electrons move through the first conductor is longer than a distance over which the electrons move through the second conductor, and therefore conductivity required for the material of the first conductor is higher than conductivity required for the material of the second conductor when consideration is given to smooth movement of electrons.

When the first conductor is made of a metal, there is a wide range of selection of a material of the first conductor, and high conductivity of the first conductor can be achieved. Examples of the metal to be used for formation of the first conductor include titanium and niobium.

On the other hand, when the first conductor is formed of a transparent conductive material, a surface on the first conductor side, or a surface on a side opposite to the foregoing surface, or each of both the surfaces may be the light-incident surface in the photoelectrode, and therefore a degree of freedom of the light-incident surface is high. Since it is also possible to produce the first conductor by use of the same material as that of the second conductor, the first conductor and the second conductor can be industrially easily and conveniently produced. As the transparent conductive material of the first conductor, the transparent conductive oxides shown as an example as the transparent conductive material to be used for formation of the second conductor can be used, and among them, FTO and ATO are suitably used. As described above, FTO and ATO have high-temperature resistance, and therefore can be used without problems even when the step of forming a visible-light photocatalyst includes a firing process.

Preferably, the first conductor is formed of a material having a resistivity lower than that of the second conductor. Preferably, the first conductor has conductivity higher than that of the second conductor. A distance over which electrons move is usually larger in the first conductor than in the second conductor. Thus, a movement loss of electrons can be suppressed by making the resistivity of the first conductor lower than the resistivity of the second conductor. This configuration can be provided by, for example, forming the first conductor from a metal and forming the second conductor from a transparent conductive oxide. Specific examples of the metal that can be used for formation of the first conductor and specific examples of the transparent conductive oxide that can be used for formation of the second conductor are as described above. By forming the first conductor from a first transparent conductive oxide, and forming the second conductor from a second transparent conductive oxide having a resistivity higher than that of the first transparent conductive oxide, a photoelectrode can be provided in which the first conductor and the second conductor are both transparent, and the resistivities of the first conductor and the second conductor satisfy the above-mentioned relationship.

One example of a method for manufacturing the photoelectrode of this exemplary embodiment will now be described. In one example of the method for manufacturing the photoelectrode of this exemplary embodiment, a second conductor which has a porous structure including a three-dimensionally continuous skeleton and pores formed by the skeleton, and is transparent is first formed on a first conductor as a substrate, and a visible-light photocatalyst which is disposed in the pores of the second conductor is then formed.

Since the manufacturing method does not include complicated steps, a photoelectrode can be manufactured at a low cost. Details of materials of the first conductor to be used and the second conductor and visible-light photocatalyst to be formed in the manufacturing method are as described above.

When a visible-light photocatalyst containing at least one selected from a nitride and an oxynitride is formed, the visible-light photocatalyst can be formed by, for example, subjecting an oxide or an organic compound as a precursor of the visible-light photocatalyst to a nitridization treatment with a nitrogen compound gas (e.g. an ammonia gas).

When the visible-light photocatalyst is a niobium oxynitride such as niobium oxynitride (NbON), the visible-light photocatalyst can be formed by, for example, subjecting the niobium oxynitride as a precursor to a nitridization treatment with an ammonia gas. The nitridization treatment can be performed under atmospheric pressure. The nitridization treatment is performed under atmospheric pressure, and thus as compared to a case where the nitridization treatment is performed under vacuum, necessity of complicated steps is eliminated, and a simpler apparatus can be used, so that costs of the photoelectrode can be further reduced. The nitridization treatment using an ammonia gas can be performed, for example, at a temperature in a range from 500° C. to 750° C., preferably in a range from 500° C. to 650° C. When the nitridization treatment is performed at a temperature in the range as described above, a sufficient nitridization treatment can be performed because the temperature is high enough to thermally decompose ammonia, and conductivity of the second conductor can be maintained after the treatment.

On the other hand, when the visible-light photocatalyst is a niobium nitride such as niobium nitride (Nb₃N₅), the visible-light photocatalyst can be formed by, for example, nitriding an organic niobium compound by reacting the organic niobium compound with an ammonia gas. As the organic niobium compound, for example, a compound represented by a compositional formula: Nb(NR₂)₅ (where R represents an alkyl group having 1 to 3 carbon atoms) (e.g. pentakis(dimethylamino)niobium) and a compound represented by a compositional formula: R¹N═Nb(NR²R³)₃ (where R¹, R² and R³ each independently represent a hydrocarbon group) can be used. A temperature for the nitridization treatment is, for example, equal to or higher than a nitridization initiation temperature of the organic niobium compound and lower than a reduction initiation temperature of Nb.

A method for forming the second conductor is not particularly limited. For example, the second conductor can be formed in the following manner: a paste is prepared by appropriately adding a solvent, a surfactant and so on to a powder of a material that forms a skeleton, the paste is applied onto the provided first conductor to form a film, and the film is fired. An atmosphere and a temperature condition during firing can be appropriately selected according to a material to be used. The second conductor having a configuration in which the skeleton is dense in a region on the first conductor side, and sparse in a region on a side opposite to the first conductor as described above can be formed by using, for example, a powder having a smaller particle size as a powder used for formation of the second conductor in the region on the first conductor side, and a powder having a larger particle size as a powder used for formation of the second conductor in the region on a side opposite to the first conductor.

### Second Exemplary Embodiment

One exemplary embodiment of a photoelectrochemical cell of the present disclosure will be described.

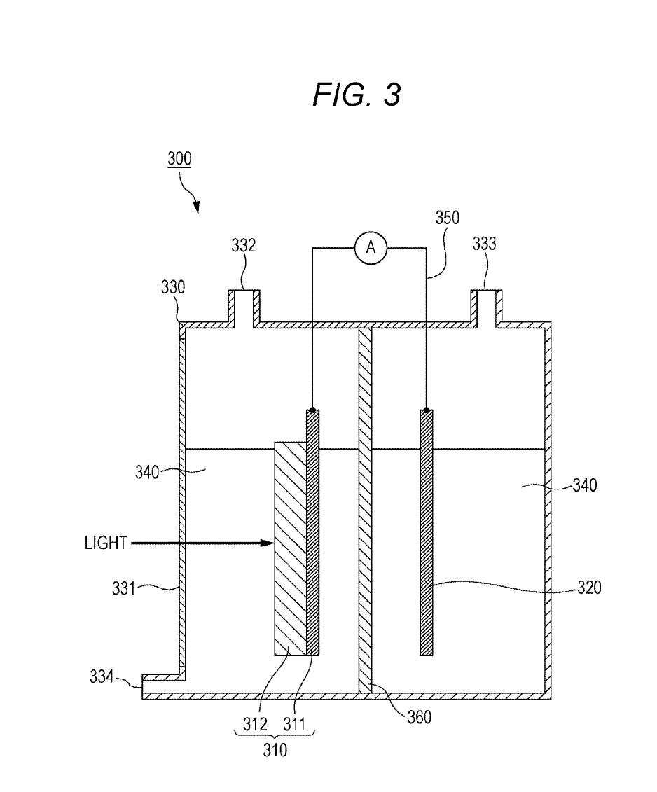

FIG. 3 shows one example of the photoelectrochemical cell of this exemplary embodiment. Photoelectrochemical cell 300 shown in FIG. 3 includes photoelectrode 310; counter electrode 320; electrolytic solution 340 containing water; and container 330 that stores photoelectrode 310, counter electrode 320, and electrolytic solution 340.

As photoelectrode 310, the photoelectrode described in the first exemplary embodiment is used. Photoelectrode 310 includes first conductor 311 as a substrate, and composite 312 disposed on first conductor 311 and composed of a second conductor and a visible-light photocatalyst. The second conductor has a porous structure including a three-dimensionally continuous skeleton and pores formed by the skeleton, and is transparent as described in the first exemplary embodiment. The visible-light photocatalyst is disposed in the pores of the second conductor. Details of first conductor 311, the second conductor and the visible-light photocatalyst are as described in the first exemplary embodiment, and therefore are not described here.

In container 330, photoelectrode 310 and counter electrode 320 are disposed in such a manner that surfaces of photoelectrode 310 and counter electrode 320 are in contact with electrolytic solution 340. In photoelectrochemical cell 300 shown in FIG. 3, a section of container 330 which faces composite 312 of photoelectrode 310 disposed in container 330 (hereinafter, abbreviated as light-incident section 331) is made of a material that transmits light such as sunlight. In photoelectrochemical cell 300, photoelectrode 310 is disposed in container 330 in such a direction that light is capable of being incident from a surface on a side opposite to first conductor 311. In other words, the light-incident surface in photoelectrode 310 is the surface on a side opposite to the first conductor. Thus, first conductor 311 of photoelectrode 310 may be formed of a metal, or may be formed of a transparent conductive material. When first conductor 311 is formed of a metal, a part of light having passed through composite 312 is reflected on a surface of first conductor 311, then enters composite 312 again, and is absorbed by the visible-light photocatalyst, and therefore light utilization efficiency can be further improved.

First conductor 311 in photoelectrode 310 and counter electrode 320 are electrically connected by lead wire 350. The counter electrode herein means an electrode that sends and receives electrons between itself and a photoelectrode without passage through an electrolytic solution. Thus, counter electrode 320 in this exemplary embodiment has only to be electrically connected to first conductor 311 that forms photoelectrode 310, and a positional relation between counter electrode 320 and photoelectrode 310, etc. is not particularly limited. For example, when the visible-light photocatalyst to be used in photoelectrode 310 is an n-type semiconductor, counter electrode 320 is an electrode that receives electrons from photoelectrode 310 without passage through electrolytic solution 340. Preferably, a material having a small overvoltage is used for counter electrode 320. For example, use of a metal catalyst such as Pt, Au, Ag, Fe or Ni is preferable because activity of counter electrode 320 is improved.

As shown in FIG. 3, photoelectrochemical cell 300 may further include separator 360. An inside of container 330 can be partitioned by separator 360 into two regions: a region where photoelectrode 310 is disposed and a region where counter electrode 320 is disposed. Electrolytic solution 340 is stored in both the regions. Container 330 includes exhaust port 332 for exhausting a gas produced in the region where photoelectrode 310 is disposed; and exhaust port 333 for exhausting a gas produced in the region where counter electrode 320 is disposed. Container 330 further includes water supply port 334 for supplying water into container 330.

Electrolytic solution 340 is not particularly limited as long as it contains water. Electrolytic solution 340 may be acidic or alkaline. A solid electrolyte can be used in place of electrolytic solution 340. Water can be used in place of electrolytic solution 340.

Operations of photoelectrode 310 and photoelectrochemical cell 300 will now be described. Here, an explanation is given taking as an example a case where the visible-light photocatalyst of photoelectrode 310 is an n-type semiconductor such as NbON.

When sunlight is incident from light-incident section 331 of container 330 in photoelectrochemical cell 300 to photoelectrode 310 which is stored in container 330 and is in contact with electrolytic solution 340, electrons are produced in a conduction band, and holes are produced in a valence band in the visible-light photocatalyst in composite 312. Holes produced here move to a surface of the visible-light photocatalyst due to band bending by a depletion layer generated as a result of contact with electrolytic solution 340. On the surface of the visible-light photocatalyst, water is decomposed to produce oxygen in accordance with the following reaction formula (1). On the other hand, electrons move to the second conductor due to the band bending, and arrive at counter electrode 320 by way of first conductor 311. At counter electrode 320, hydrogen is produced in accordance with the following reaction formula (2).

4h⁺+2H₂O→O₂↑+4H⁺ (1)

4e⁻+4H⁺→2H₂↑ (2)

Produced hydrogen and oxygen are separated from each other by separator 360 in the container, and oxygen is discharged through exhaust port 332 while hydrogen is exhausted through exhaust port 333. Water to be decomposed is supplied into container 330 through water supply port 334.

Photoelectrode 310 is capable of utilizing energy of light with high efficiency as described in the first exemplary embodiment. Thus, photoelectrochemical cell 300 including photoelectrode 310 is capable of effectively utilizing energy of light for a water decomposition reaction.

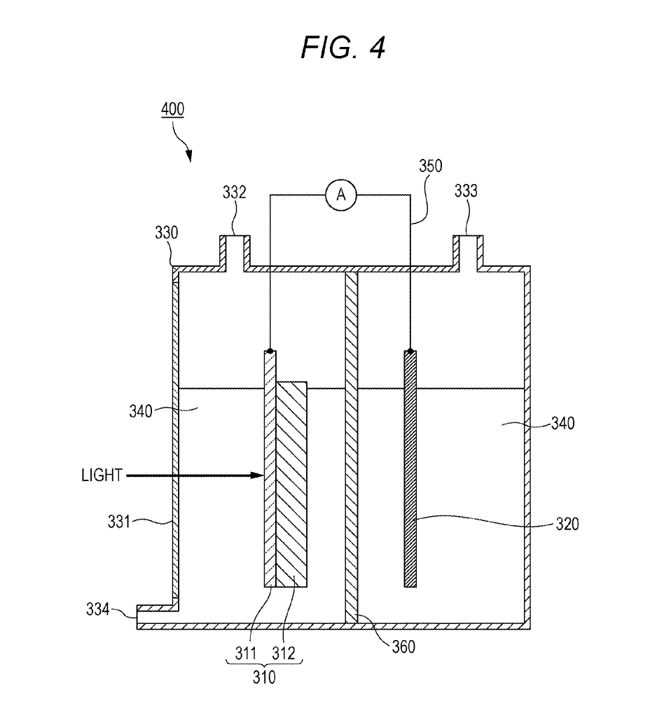

FIG. 4 shows another example of the photoelectrochemical cell. Photoelectrochemical cell 400 shown in FIG. 4 is different from photoelectrochemical cell 300 in direction of disposition of photoelectrode 310, but has the same configuration as that of photoelectrochemical cell 300 in other points. Thus, only the direction of disposition of photoelectrode 310 is described here. In photoelectrochemical cell 400, photoelectrode 310 is disposed in such a direction that first conductor 311 faces light-incident section 331 of container 330, i.e. photoelectrode 310 is disposed in container 330 in such a direction that light is capable of being incident from a surface on a first conductor 311 side. In other words, the light-incident surface in photoelectrode 310 is the surface on the first conductor 311 side. First conductor 311 is required to transmit incident light, so that the light arrives at composite 312. Thus, in photoelectrochemical cell 400, first conductor 311 of photoelectrode 310 is required to be formed of a transparent conductive material.

Operations of photoelectrochemical cell 400 when light is incident on photoelectrode 310 are the same as operations of photoelectrochemical cell 300 except that light arriving at composite 312 is light having passed through first conductor 311. In photoelectrochemical cell 400, light is incident on photoelectrode 310 from the first conductor 311 side, and therefore an amount of light absorbed by the visible-light photocatalyst disposed at a position close to first conductor 311 increases. Thus, a distance over which carriers photo-excited by the visible-light photocatalyst move to first conductor 311 is shorter as compared to the case of photoelectrochemical cell 300, and therefore recombination of carriers is hard to occur. As a result, in photoelectrochemical cell 400, an amount of carriers capable of contributing to the water decomposition reaction increases as compared to photoelectrochemical cell 300, so that high utilization efficiency of energy of light can be achieved. Photoelectrochemical cell 400 can be made to have a configuration in which light is incident on the photoelectrode from both of a surface on the first conductor side and a surface on a side opposite to the foregoing surface rather than only from the surface on the first conductor 311 side.

Configurations of components other than photoelectrode 310 in photoelectrochemical cells 300 and 400, for example, counter electrode 320, container 330, lead wire 350, and separator 360 are not particularly limited, and a known container, a known lead wire, a known separation membrane and so on which are used in a photoelectrochemical cell that decomposes water to produce a gas such as hydrogen can be appropriately used.

### EXAMPLES

Hereinafter, the photoelectrode of the present disclosure will be described further in detail with reference to examples.

<Production of Photoelectrode>

### Example 1

(1) Step of Forming Second Conductor (Antimony-Doped Tin Oxide: ATO)

An ATO substrate was provided as a first conductor. An ATO powder having a primary particle size of 120 nm to 250 nm was used as a transparent conductive oxide for producing a second conductor. An ink with the ATO powder dispersed in an organic solvent was prepared, deposited on the ATO substrate by spin coating, and dried for about 5 minutes on a hot plate set at 120° C. Conditions for spin coating included rotation at a rotation number of 400 rpm for 20 seconds, followed by rotation at a rotation number of 1500 rpm for 10 seconds. After the drying, the film on the ATO substrate was fired in a mixed gas stream of oxygen and nitrogen. In the firing, a temperature in a furnace was elevated from room temperature to 500° C. at a temperature elevation rate of 100° C./h, held at 500° C. for 1 hour, and then lowered at a temperature falling rate of 100° C./h, and the film was taken out from the furnace at the time when the temperature reached around room temperature.

Observation of a cross-section of the produced film with a scanning electron microscope (SEM) showed that the film had a thickness of about 4 μm. It was confirmed that the film had a porous structure, where ATO particles were three-dimensionally connected to form a skeleton, and three-dimensionally continuous pores formed by the skeleton existed.

The above-mentioned method was used in this example, but a method for producing a TiO₂ electrode used for dye-sensitized solar cells is also useful as a method for forming the second conductor. For example, the second conductor having a porous structure can be formed in the following manner: a powder of a transparent conductive material for production of the second conductor is provided in place of a TiO₂ powder, and mixed together with pure water, acetyl acetone, a surfactant (Toriton-X) and so on by a mortar to prepare a paste, and the paste is applied onto the first conductor by a squeegee method, and dried and fired.

(2) Step of Forming Visible-Light Photocatalyst (Niobium Oxynitride: NbON)

A sample obtained by applying an amorphous Nb₂O₅ thin film as a precursor to an ATO substrate by a sputtering method was provided. The sample was set in a Tammann tubular furnace having a diameter of about 9 cm (manufactured by Motoyama K.K.), and a temperature in the furnace was elevated from room temperature to 600° C. at a temperature elevation rate of 100° C./h under flow of a mixed gas of ammonia, oxygen and nitrogen. Thereafter, the sample was held at 600° C. for 1 hour, the temperature was then lowered at a temperature falling rate of 100° C./h, purging was sufficiently performed with the fed gas changed from the reaction gas to nitrogen, and a resulting synthesized product was taken out from the furnace. A total flow rate of the mixed gas was set to 1000 mL/min. A composition ratio of the mixed gas was set to 40.00% (volume percent) for ammonia, 0.06% (volume percent) for oxygen and 59.94% (volume percent) for nitrogen.

XRD measurement performed for the synthesized product after firing showed that a peak of NbON of vaderite structure existed. In other words, it was confirmed that a structure with NbON disposed on an ATO substrate (ATO substrate-NbON structure) was formed.

Examination of light absorption properties of the resulting ATO substrate-NbON structure by diffuse reflectance measurement showed that light absorption considered as an interband transition of NbON existed in a visible light region, and an absorption edge wavelength in the light absorption was about 600 nm.

Thus, it has been confirmed that NbON as a visible-light photocatalyst can be synthesized by subjecting the precursor Nb₂O₅ to a nitridization treatment.

In this example, Nb₂O₅ as a precursor was deposited on the ATO substrate by a sputtering method for determining whether NbON as a visible-light photocatalyst can be synthesized by subjecting the precursor Nb₂O₅ to a nitridization treatment. However, the sputtering method is not suitable for a method for depositing a precursor on a porous structure corresponding to the second conductor. This is because it is difficult to deposit the precursor Nb₂O₅ also on insides of pores of the porous structure by the sputtering method. Examples of methods capable of relatively uniformly depositing the precursor Nb₂O₅ also on insides of pores of the porous structure include the following (1) and (2).

(1) A solution of niobium ethoxide (Nb(OC₂H₅)₅) diluted to 10 mM with ethanol is prepared. The solution is applied onto a porous structure as the second conductor, and dried at about 100° C. Accordingly, niobium ethoxide is hydrolyzed, so that an amorphous niobium oxide (Nb₂O₅) is deposited also on insides of pores of the porous structure.
(2) A solution of niobium ethoxide (Nb(OC₂H₅)₅) diluted to 10 mM with ethanol is prepared. An ATO powder is dispersed in the solution to prepare an ink. The ink is deposited on an ATO substrate by spin coating, and then dried and fired to produce a structure in which a niobium oxide (Nb₂O₅) is deposited on insides of pores of ATO having a porous structure.

<Examination of Resistance of Second Conductor to Heat Treatment in Step of Forming Visible-Light Photocatalyst>

Here, when a niobium oxynitride such as NbON is obtained by nitriding a niobium oxide through a nitridization reaction with an ammonia gas, a firing temperature is preferably 500° C. or higher. This is because the nitridization reaction is caused by, for example, highly reactive radical nitrogen atoms produced in thermal decomposition of an ammonia gas, and as described in Non Patent Literature 1 (Appl. Phys. Lett. 72 (3), 19 Jan. 1998), thermal decomposition of ammonia occurs at about 500° C. or higher.

On the other hand, when placed in a high-temperature atmosphere, a transparent conductive oxide that can be used as a material of the second conductor may have a markedly reduced conductivity because, for example, a carrier density decreases. Thus, when a niobium oxynitride and/or a niobium nitride is formed as a visible-light photocatalyst on the second conductor, it is preferable to synthesize the niobium oxynitride and/or niobium nitride in a low temperature condition.

For examining resistance of the second conductor to a heat treatment in a step of forming a visible-light photocatalyst, substrates of ATO, FTO and GZO that can be used as a material of the second conductor were provided, and these substrates were fired under nitridization conditions similar to those in the step of forming a visible-light photocatalyst in (2). Resultantly, for all the substrates, there was no significant change in resistance value after firing, and conductivity was maintained. When a heat treatment was performed at a peak temperature of 650° C. for the three substrates, there was no significant change in resistance value after firing for ATO and FTO, but the resistance value increased for GZO. This may be because oxygen existed in a firing atmosphere as a condition of this experiment, and therefore the resistance value of the GZO substrate increased. When the three substrates were fired at an assumed nitridization temperature of 750° C., the resistance value increased after firing for all the substrates. From these experiments, it has been confirmed that when a visible-light photocatalyst containing at least one selected from a nitride and an oxynitride is formed on a surface of the second conductor through a nitridization treatment using an ammonia gas, a temperature in the nitridization treatment is preferably in a range from 500° C. to 650° C.

### INDUSTRIAL APPLICABILITY

The photoelectrode of the present disclosure is useful as an electrode for water decomposition using sunlight.

### REFERENTIAL SIGNS LIST

100, 310: Photoelectrode
101, 311: First conductor
102: Second conductor
102a: Skeleton
102b: Pore
102c: Position farthest from reference plane in skeleton of second conductor
103: Visible-light photocatalyst
104, 312: Composite
201: Reference plane
202: Thickness determination plane
203: Central plane
204: Region on first conductor side
205: Region on side opposite to first conductor
300, 400: Photoelectrochemical cell
320: Counter electrode
330: Container
331: Light-incident section
332, 333: Exhaust port
334: Water supply port
340: Electrolytic solution
350: Lead wire
360: Separator

1. A photoelectrode comprising:
a first conductor as a substrate;
a second conductor which is disposed on the first conductor, has a porous structure including a three-dimensionally continuous skeleton and pores formed by the skeleton, and is transparent; and
a visible-light photocatalyst disposed in the pores of the second conductor.

2. The photoelectrode according to claim 1, wherein
the visible-light photocatalyst contains at least one of a niobium nitride and a niobium oxynitride.

3. The photoelectrode according to claim 1, wherein
a resistivity of the first conductor is lower than a resistivity of the second conductor.

4. The photoelectrode according to claim 3, wherein
the first conductor is formed of a metal; and
the second conductor is formed of a transparent conductive oxide.

5. The photoelectrode according to claim 3, wherein
the first conductor is formed of a first transparent conductive oxide;
the second conductor is formed of a second transparent conductive oxide; and
a resistivity of the first transparent conductive oxide is lower than a resistivity of the second transparent conductive oxide.

6. The photoelectrode according to claim 1, wherein
the second conductor is formed of at least one selected from the group consisting of antimony-doped tin oxide, fluorine-doped tin oxide and gallium-doped zinc oxide.

7. The photoelectrode according to claim 6, wherein
the porous structure is a co-continuous structure, or a particulate porous structure in which the skeleton is formed by aggregation of fine particles.

8. The photoelectrode according to claim 1, wherein
in the second conductor, a porosity of a region on a first conductor side with respect to a central plane of the second conductor is lower than a porosity of a region on a side opposite to the first conductor with respect to the central plane;
the central plane is a central plane in a thickness of the second conductor;
the thickness of the second conductor is determined by a distance between a reference plane and a thickness determination plane where the reference plane is a surface of the first conductor on which the second conductor is disposed, and the thickness determination plane is a plane which extends through a position farthest from the reference plane in the skeleton of the second conductor, and is parallel to the reference plane; and
the central plane in the thickness of the second conductor is a central plane between the reference plane and the thickness determination plane.

9. A method for manufacturing the photoelectrode, the method comprising:
forming, on a first conductor as a substrate, a second conductor which has a porous structure including a three-dimensionally continuous skeleton and pores formed by the skeleton, and is transparent; and
forming a visible-light photocatalyst disposed in the pores of the second conductor.

10. The method for manufacturing a photoelectrode according to claim 9, wherein
the visible-light photocatalyst is at least one selected from a nitride and an oxynitride; and
the visible-light photocatalyst is formed by subjecting an oxide or an organic compound as a precursor of the visible-light photocatalyst to a nitridization treatment with a nitrogen compound gas.

11. A photoelectrochemical cell comprising:
the photoelectrode according to claim 1;
a counter electrode electrically connected to the photoelectrode; and
a container that stores the photoelectrode and the counter electrode.

12. The photoelectrochemical cell according to claim 11, further comprising:
an electrolytic solution which contains water, which is stored in the container and which is in contact with surfaces of the photoelectrode and the counter electrode.

13. The photoelectrochemical cell according to claim 11, wherein
the first conductor of the photoelectrode is formed of a metal; and
the photoelectrode is disposed in such a direction that light is capable of being incident from a surface on a side opposite to the first conductor.

14. The photoelectrochemical cell according to claim 11, wherein
the first conductor of the photoelectrode is formed of a transparent conductive material; and
the photoelectrode is disposed in such a direction that light is capable of being incident from a surface on a first conductor side.

15. A method for producing hydrogen comprising:
(a) providing a photoelectrochemical cell comprising:
the photoelectrode according to claim 1;
a counter electrode electrically connected to the photoelectrode;
a liquid that is in contact with the photoelectrode and the counter electrode; and
a container that stores the photoelectrode, the counter electrode and the liquid,
the liquid being water or an electrolyte aqueous solution; and
(b) irradiating the photoelectrode with light to produce hydrogen on a surface of the counter electrode.
